(19) United States
(12) Patent Application Publication
(10) Pub. No.: US 2026/0357082 A1
(43) Pub. Date: Nov. 12, 2026

(54) NON-SILICONE PROTECTIVE COATINGS FOR AUTO CARE APPLICATIONS

(71) Applicant: BASF SE, Ludwigshafen am Rhein (DE)

(72) Inventors: Scott A. Walters, Parkville, MO (US); Simone R. Bright, Detroit, MI (US)

(73) Assignee: BASF SE, Ludwigshafen am Rhein (DE)

(21) Appl. No.: 19/127,167

(22) PCT Filed: Nov. 30, 2023
(86) PCT No.: PCT/US2023/081760

§ 371 Date: May 5, 2025

Related U.S. Application Data
(60) Provisional application No. 63/386,043, filed on Dec. 5, 2022.

(51) Int. Cl. C09D 5/02; C09D 7/65; C09D 171/02; C09D 183/06; C09G 1/16; C09G 1/18

(52) U.S. Cl. CPC C09D 5/024; C09D 5/022; C09D 7/65; C09D 171/02; C09D 183/06; C09G 1/16; C09G 1/18

(57) ABSTRACT

Described herein are aqueous and non-aqueous compositions and methods of use thereof, where the compositions are free of silicones, and include an effective amount of a water insoluble surfactant, such as a fatty alcohol ethoxylate, a polyoxyethylene-polyoxypropylene block polymer, or mixtures thereof, and a suitable carrier.

### CROSS-REFERENCE TO RELATED APPLICATION

This application claims priority to U.S. Provisional Application No. 63/386,043, filed Dec. 5, 2022, the contents of which are hereby incorporated by reference herein.

### FIELD

The present disclosure relates to compositions comprising water insoluble surfactants that provide appearance enhancing and protectant properties when applied to various substrate surfaces, and methods of use thereof. More specifically, the present disclosure relates to non-silicone compositions comprising water insoluble surfactants, such as fatty alcohol ethoxylates, polyoxyethylene-polyoxypropylene block polymers, and combinations thereof, that provide appearance enhancing and protectant properties when applied to various substrate surfaces, and methods of use thereof.

### BACKGROUND

Silicone-based compounds, such as polydimethylsiloxane, are traditionally used in dispersions and emulsions to provide or impart an aesthetically desired shiny and/or darkening of the surface of rubber (tires), vinyl, and leather in auto care applications. In recent years, however, silicone fluids have been difficult to procure due to issues with imports and plant shutdowns, as well as price increases.

Non-silicone materials, such as glycerin or polyalkylene glycol based dressings and protectants, are also available as alternatives to silicone-based materials when such materials are undesirable. However, lower cost and more readily-available non-silicone-based options are needed.

### SUMMARY

The present disclosure provides for imparting appearance enhancing and protectant properties to a surface by applying compositions comprising water insoluble surfactants.

Various aspects of the disclosure relate to compositions, such as protective coating compositions, comprising an effective amount of a water insoluble surfactant and a suitable carrier.

In various aspects, the water insoluble surfactant may be selected from fatty alcohol ethoxylates, polyoxyethylene-polyoxypropylene block polymers, and mixtures thereof.

In various aspects, the composition may be free of silicone.

In various aspects, the composition may be aqueous or non-aqueous.

Various aspects of the disclosure additionally relate to a use of a composition comprising an effective amount of a water insoluble surfactant and a suitable carrier as a coating or polish for a substrate.

Various aspects of the disclosure additionally relate to a method of using a composition, the method comprising applying a composition comprising an effective amount of a water insoluble surfactant and a suitable carrier to a substrate.

In various aspects, the composition may be applied to a substrate comprising a material selected from the group consisting of rubber, vinyl, leather, and combinations thereof.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges stated herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

As used herein, the terms “comprises”, “comprising”, “includes”, “including”, “has”, “having”, or any other variation thereof, are intended to cover a non-exclusive inclusion. For example, a process, method, article or apparatus that comprises a list of elements is not necessarily limited to only those elements, but may include other elements not expressly listed or inherent to such process, method, article, or apparatus.

As used herein, the term “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

Where an invention or a portion thereof is defined with an open-ended term such as “comprising,” it should be readily understood that (unless otherwise stated) the description should be interpreted to also describe such an invention using the term “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “wt %” refers to a percent by weight of the recited component relative to a total weight of the recited composition.

The present disclosure provides for compositions comprising water insoluble surfactants that provide appearance enhancing and protectant properties when applied to various substrate surfaces, and methods of use thereof.

The compositions and methods disclosed herein may provide a lower cost and more readily available alternative or replacement for silicone fluids for application as appearance enhancing (shine, gloss, wet look) dressings and protectants for various surfaces in, for example, auto care applications. More specifically, the compositions and methods disclosed herein may provide a non-silicone-based compound having gloss enhancing and surface protecting properties, as well as longevity and water and/or detergent resistance.

As used herein, the term “an effective amount” refers to any amount of a water insoluble surfactant that is effective in imparting appearance enhancing and protective properties to a substrate surface.

As used herein, the term “co-surfactant” refers to a surfactant that may be used in compositions of the present disclosure, in combination with, for example, the primary water insoluble surfactant to improve the emulsification of the ingredients.

In various aspects of the present disclosure, a composition for providing appearance enhancing and protectant properties to a surface or substrate is disclosed. In various aspects, the composition may include an effective amount of one or more water insoluble surfactants and a suitable carrier. In various aspects, the composition may be in the form of a coating composition.

In some aspects, the composition may include any amount of a water insoluble surfactant that is effective in providing appearance enhancing and protectant properties to a surface. In some aspects, the water insoluble surfactant may be present in an amount of between about 5% to about 60% by weight of the composition, or about 5%, 10%, 15%, 20%, 25%, 30%, 35%, 40%, 45%, 50%, 55%, or 60% by weight of the composition, or any amount that falls between any of these percentages.

In various aspects, suitable water insoluble surfactants may include any water insoluble surfactant compounds that are effective in imparting appearance enhancing and protectant properties to the composition of the disclosure. In some aspects, suitable water insoluble surfactants may be cationic, anionic, zwitterionic or nonionic. In some aspects, suitable water insoluble surfactants may include, but are not limited to, nonionic surfactant compounds, such as low-foaming nonionic surfactants, including surfactants selected from fatty alcohol ethoxylates, such as C₁₆-C₁₈ alkoxylates, C₁₃-C₁₅ alkoxylates, C₁₂-C₁₅ alkoxylates, C₄ alkoxylates, or mixtures thereof, polyoxyethylene-polyoxypropylene block polymers, such as alkyl and alkenyl alkoxylates of the type R-EOₙ/POₘ in which R are generally linear or branched C₆-C₃₀ alkyl radicals, or C₈-C₂₀ alkyl radicals, EO is an ethylene oxide unit and PO is a propylene oxide unit, the sequential arrangement of EO and PO being arbitrary, and n and m independently of one another being >1 and <100, or >3 and <50, or alkylphenol ethoxylates, EO/PO block copolymers, or mixtures thereof.

In various aspects, suitable water insoluble surfactants may be characterized by a hydrophilic-lipophilic balance (HLB) of less than about 6.0, or less than about 6.0, about 5.0, about 4.0, about 3.0, about 2.0 or about 1.0, or any HLB between any of these values.

In various aspects, the compositions of the disclosure may be aqueous or non-aqueous. In some aspects, the compositions of the disclosure may include a suitable carrier, such as an aqueous or non-aqueous solvent carrier.

In some aspects, the compositions of the disclosure may be in the form of an aqueous mixture comprising the water insoluble surfactant and an aqueous carrier. The aqueous mixture may include a co-surfactant to emulsify and/or couple the water insoluble surfactant to form an aqueous emulsion. In various aspects, suitable co-surfactants may include any surfactant effective in emulsifying and/or coupling the water insoluble surfactant to form an aqueous emulsion.

In some aspects, suitable co-surfactants may include an HLB in a range of from about 8.0 to about 14.0. In some aspects, suitable co-surfactants may be characterized by an HLB of at least about 8.0, about 9.0, about 10.0, about 11.0, about 12.0, or about 13.0. In various aspects, suitable co-surfactants may be characterized by an HLB of at most about 9.0, about 10.0, about 11.0, about 12.0, about 13.0, or about 14.0.

In some aspects, suitable co-surfactants are selected from castor oil ethoxylates, hydrogenated castor oil ethoxylates, oleyl alcohol (fatty alcohol) ethoxylates, tridecyl alcohol ethoxylates, nonyl phenol ethoxylates, tallow amine ethoxylates, linear alcohol ethoxylates, lauryl alcohol ethoxylates, C10 Guerbet alcohol alkoxylates, decyl alcohol ethoxylates, dodecyl alcohol ethoxylates, ethylhexyl alkoxylates, octyl phenol ethoxylates, polyoxyethylene-polyoxypropylene block co-polymers, alkoxylated fatty alcohols, polyethylene glycol (PEG) esters, fatty amine ethoxylates, ethoxylated glyceryl esters, fatty alcohol ethoxylates, ethoxylates, alkoxylates, glycerol esters, ethoxylated sorbitan ester, quaternary ammonium compounds, aliphatic amines, and combinations thereof.

In other aspects, the compositions may be in the form of a non-aqueous dispersion or emulsion comprising the water insoluble surfactant and a non-aqueous solvent carrier. Suitable non-aqueous solvent carriers may include, but are not limited to, glycol ethers, alcohols, mineral spirits and mixtures thereof.

In various aspects, the compositions of the present disclosure may include limited amounts of silicone. As used herein, “silicone” refers to silicone-based compounds, such as polydimethylsiloxane and the like.

In some aspects, the compositions include silicone. In some aspects, the compositions include silicone in an amount in a range of from about 0 wt % to about 50 wt %. In some aspects, the compositions include silicone in an amount in a range of from about 0 wt % to about 30 wt %.

In some aspects, the compositions include silicone in an amount of at least about 0 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 2.5 wt %, about 3.0 wt %, about 3.5 wt %, about 4.0 wt %, about 4.5 wt %, about 5.0 wt %, about 5.5 wt %, about 6.0 wt %, about 6.5 wt %, about 7.0 wt %, about 7.5 wt %, about 8.0 wt %, about 8.5 wt %, about 9.0 wt %, about 9.5 wt %, about 10.0 wt %, about 11 wt %, about 12 wt %, about 13 wt %, about 14 wt %, about 15 wt %, about 16 wt %, about 17 wt %, about 18 wt %, about 19 wt %, about 20.0 wt %, about 21 wt %, about 22 wt %, about 23 wt %, about 24 wt %, about 25 wt %, about 26 wt %, about 27 wt %, about 28 wt %, about 29 wt %, about 30.0 wt %, about 31 wt %, about 32 wt %, about 33 wt %, about 34 wt %, about 35 wt %, about 36 wt %, about 37 wt %, about 38 wt %, about 39 wt %, about 40.0 wt %, about 41 wt %, about 42 wt %, about 43 wt %, about 44 wt %, about 45 wt %, about 46 wt %, about 47 wt %, about 48 wt %, or about 49 wt %. In some aspects, the compositions include silicone in an amount of at most about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 2.5 wt %, about 3.0 wt %, about 3.5 wt %, about 4.0 wt %, about 4.5 wt %, about 5.0 wt %, about 5.5 wt %, about 6.0 wt %, about 6.5 wt %, about 7.0 wt %, about 7.5 wt %, about 8.0 wt %, about 8.5 wt %, about 9.0 wt %, about 9.5 wt %, about 10.0 wt %, about 11 wt %, about 12 wt %, about 13 wt %, about 14 wt %, about 15 wt %, about 16 wt %, about 17 wt %, about 18 wt %, about 19 wt %, about 20.0 wt %, about 21 wt %, about 22 wt %, about 23 wt %, about 24 wt %, about 25 wt %, about 26 wt %, about 27 wt %, about 28 wt %, about 29 wt %, about 30.0 wt %, about 31 wt %, about 32 wt %, about 33 wt %, about 34 wt %, about 35 wt %, about 36 wt %, about 37 wt %, about 38 wt %, about 39 wt %, about 40.0 wt %, about 41 wt %, about 42 wt %, about 43 wt %, about 44 wt %, about 45 wt %, about 46 wt %, about 47 wt %, about 48 wt %, about 49 wt %, or about 50 wt %.

In various aspects, the compositions of the present disclosure may be free of silicone.

In various aspects, the present disclosure may include a method for using a composition, the method comprising applying a composition comprising an effective amount of a water insoluble surfactant to a surface or substrate. In some aspects, the present disclosure may include a method for forming a protective coating on a surface or substrate comprising applying a composition comprising an effective amount of a water insoluble surfactant to the surface or substrate. In some aspects, suitable surfaces and substrates for application of the composition of the disclosure may include any surface or substrate that would benefit from the appearance enhancement and protectant properties of the composition of the disclosure.

In some aspects, suitable surfaces or substrates for application of the composition of the disclosure may include one or more materials selected from rubber, vinyl, leather, and combinations thereof.

In some aspects, suitable surfaces or substrates for application of the composition of the disclosure may include one or more of rubber-based substrates, vinyl substrates, leather substrates, and the like.

In various aspects, compositions of the present disclosure may be in the form of a formulation selected from coating compositions, tire shine formulations, vinyl polish formulations, and combinations thereof.

Generally, a tire shine formulation is a formulation applied to rubber tires, such as rubber automotive tires. Tire shine formulations may protect tire sidewalls from harmful UV rays, dry rotting, and cracking, and make rubber surfaces appear like a wet and shiny tire. Tire shine formulations may also serve to provide tire dressing, waxing, and/or sealing.

Generally, a vinyl polish formulation is a formulation applied to a vinyl. The vinyl may be an automotive vinyl, such as in an automotive interior component, like a dashboard, seats, door panels, or a center console. Vinyl polish formulations can help to protect these surfaces from fading, cracking, and other types of damage that can occur over time due to exposure to sunlight, heat, and other environmental factors.

In some aspects, the method may include applying a composition comprising any amount of a water insoluble surfactant that is effective in providing appearance enhancing and protectant properties to the surface or substrate. In some aspects, the water insoluble surfactant may be present in an amount of between about 5% to about 60% by weight of the composition, or about 5%, 10%, 15%, 20%, 25%, 30%, 35%, 40%, 45%, 50%, 55%, or 60% by weight of the composition, or any amount that falls between any of these percentages.

In various aspects, suitable water insoluble surfactants may include any water insoluble surfactant compounds that are effective in imparting appearance enhancing and protectant properties to the composition of the disclosure. In some aspects, suitable water insoluble surfactants may be cationic, anionic, zwitterionic or nonionic. In some aspects, suitable water insoluble surfactants may include nonionic surfactant compounds, such as low-foaming nonionic surfactants, including surfactants selected from fatty alcohol ethoxylates, such as C₁₆-C₁₈ alkoxylates, C₁₃-C₁₅ alkoxylates, C₁₂-C₁₅ alkoxylates, C₄ alkoxylates, or mixtures thereof, polyoxyethylene-polyoxypropylene block polymers, such as alkyl and alkenyl alkoxylates of the type R-EOₙ/POₘ in which R are generally linear or branched C₆-C₃₀ alkyl radicals, or C₈-C₂₀ alkyl radicals, EO is an ethylene oxide unit and PO is a propylene oxide unit, the sequential arrangement of EO and PO being arbitrary, and n and m independently of one another being >1 and <100, or >3 and <50, or alkylphenol ethoxylates, EO/PO block copolymers, or mixtures thereof.

In various aspects, suitable water insoluble surfactants may be characterized by an HLB of less than about 6.0, or less than about 6.0, about 5.0, about 4.0, about 3.0, about 2.0 or about 1.0, or any HLB between any of these values.

In various aspects of the disclosed method, the compositions may be aqueous or non-aqueous. In some aspects, the compositions may include a suitable carrier, such as an aqueous or non-aqueous solvent carrier.

In some aspects, the compositions may be in the form of an aqueous mixture comprising the water insoluble surfactant and an aqueous carrier. The aqueous mixture may include a co-surfactant to emulsify and/or couple the water insoluble surfactant to form an aqueous emulsion. In various aspects, suitable co-surfactants may include any surfactant effective in emulsifying and/or coupling the water insoluble surfactant to form an aqueous emulsion.

In some aspects, suitable co-surfactants may include an HLB in a range of from about 8.0 to about 14.0. In some aspects, suitable co-surfactants may be characterized by an HLB of at least about 8.0, about 9.0, about 10.0, about 11.0, about 12.0, or about 13.0. In various aspects, suitable co-surfactants may be characterized by an HLB of at most about 9.0, about 10.0, about 11.0, about 12.0, about 13.0, or about 14.0.

In some aspects, suitable co-surfactants are selected from castor oil ethoxylates, hydrogenated castor oil ethoxylates, oleyl alcohol (fatty alcohol) ethoxylates, tridecyl alcohol ethoxylates, nonyl phenol ethoxylates, tallow amine ethoxylates, linear alcohol ethoxylates, lauryl alcohol ethoxylates, C10 Guerbet alcohol alkoxylates, decyl alcohol ethoxylates, dodecyl alcohol ethoxylates, ethylhexyl alkoxylates, octyl phenol ethoxylates, polyoxyethylene-polyoxypropylene block co-polymers, alkoxylated fatty alcohols, polyethylene glycol (PEG) esters, fatty amine ethoxylates, ethoxylated glyceryl esters, fatty alcohol ethoxylates, ethoxylates, alkoxylates, glycerol esters, ethoxylated sorbitan ester, quaternary ammonium compounds, aliphatic amines, and combinations thereof.

In other aspects, the compositions may be in the form of a non-aqueous dispersion or emulsion comprising the water insoluble surfactant and a non-aqueous solvent carrier. Suitable non-aqueous solvent carriers may include glycol ethers, alcohols, mineral spirits and mixtures thereof.

In various aspects of the disclosed method, the compositions may be free of silicone-based compounds, such as poly dimethylsiloxane and the like.

### EXAMPLES

The present technology will be further described in the following examples, which should be viewed as being illustrative and should not be construed to narrow the scope of the present disclosure or limit the scope to any particular embodiments.

### Example 1

### Water-Based Formulas

### Benchmark 1: 60% Water-Based Emulsion

A benchmark 1 emulsion was prepared by mixing a silicone compound (Silicone 350 cst) with an emulsifier and water to form a silicone fluid emulsion.

### Benchmark 2: 60% Water-Based Emulsion

A benchmark 2 emulsion was prepared by mixing a silicone compound (Silicone 1000 cst) with an emulsifier and water to form a silicone fluid emulsion.

### Emulsion 1: 60% Water-Based Emulsion

An Emulsion 1 was prepared by mixing an alcohol alkoxylate with an alkyl polyethylene glycol ether (Guerbet Alcohol Ethoxylate, 9 mol EO) and water.

### Emulsion 2: 60% Water-Based Emulsion

An Emulsion 2 was prepared by mixing an ethylene oxide and propylene oxide block copolymer (Ethylene Oxide/Propylene Oxide Block Copolymer, 20% EO) with an alkyl polyethylene glycol ether (Guerbet Alcohol Ethoxylate, 7 mol EO) and water.

The compositions of the benchmark I emulsion, benchmark 2 emulsion, and Emulsions 1 and 2 are shown in Table 1 below.

TABLE 1
Water-Based Formulas.

| | Bench- | Bench- | Emulsion | Emulsion |
|---|---|---|---|---|
| | mark 1 | mark 2 | #1 | #2 |
| Ingredients | wt. (%) | wt. (%) | wt. (%) | wt. (%) |
| 60% Silicone | 60 | | | |
| Emulsion 350 cst | | | | |
| 60% Silicone | | 60 | | |
| Emulsion 1000 cst | | | | |
| Alcohol alkoxylate | | | 60 | |
| Ethylene | | | | 60 |
| Oxide/Propylene | | | | |
| Oxide Block | | | | |
| Copolymer, 20% EO | | | | |
| Guerbet Alcohol | | | 5 | |
| Ethoxylate, 9 mol EO | | | | |
| Guerbet Alcohol | | | | 5 |
| Ethoxylate, 7 mol EO | | | | |
| Deonized (DI) Water | 35 | 35 | 35 | 35 |

The benchmark 1 emulsion and Emulsions 1 and 2 were also diluted to 20% and 10% concentrations, respectively, for comparative testing.

### Example 2

### Water Based Formula Testing

The water based emulsions of Example 1 were applied to a tire wall, and the ease of rub, tackiness, shine, and darkening effects of each emulsion were evaluated. The results are shown below in Table 2.

TABLE 2
Water Based Formula Testing

| | Ease of | | | |
|---|---|---|---|---|
| Product | Rub | Tackiness | Shine | Darkening |
| Benchmark 1 60% | Easy | No | Yes | Yes |
| Benchmark 1 20% | Easy | No | Yes but slight | Yes |
| Benchmark 1 10% | Easy | No | Yes | Yes |
| Emulsion 1 60% | Easy | No | Yes | Yes |
| Emulsion 1 20% | Easy | No | Yes but slight | Yes |
| Emulsion 1 10% | Easy | No | No | Yes |
| Emulsion 2 60% | Easy | Yes | Yes | Yes |
| Emulsion 2 20% | Easy | No | Yes but slight | Yes |
| Emulsion 2 10% | Easy | No | No | Yes |

### Example 3

### Base Emulsions

Various emulsions according to the present disclosure were prepared according to the below table. These exemplary emulsions are demonstrative and non-limiting.

| | E1 | E2 | E3 |
|---|---|---|---|
| Ingredients | wt. (%) | wt. (%) | wt. (%) |
| Soft or DI Water | 35 | 67.5 | 78.33 |
| Emulsion 2 | 60 | 30 | 20 |
| Guerbet Alcohol Ethoxylate, 7 mol EO | 5 | 2.5 | 1.67 |

### Example 4

### Formulations

Various formulations according to the present disclosure were prepared according to the below tables. These exemplary formulations are demonstrative and non-limiting.

Tire shine formulations:

| | F1 | F2 | F3 |
|---|---|---|---|
| Ingredients | wt. (%) | wt. (%) | wt. (%) |
| Soft or DI Water | 50 | 70 | 50 |
| Benchmark 1 | 25 | | |
| Benchmark 2 | 25 | | |
| Glycerin | | 30 | |
| Emulsion 2 | | | 50 |

| | F4 | F5 |
|---|---|---|
| Ingredients | wt. (%) | wt. (%) |
| Organic solvent (e.g., C₁₂-C₁₄ | 70 | 70 |
| Isoparaffin, >160 °F FP) | | |
| 350 cst Polydimethylsiloxane Fluid | 15 | |
| 1000 cst Polydimethylsiloxane Fluid | 15 | |
| Ethylene Oxide/Propylene Oxide | | 30 |
| Block Copolymer, 20% EO | | |

| | F6 | F7 |
|---|---|---|
| Ingredients | wt. (%) | wt. (%) |
| Soft or DI water | 35 | 15 |
| Solubilizing solvent (e.g., | 5 | 25 |
| di(propylene glycol) methyl ether) | | |
| Ethylene Oxide/Propylene Oxide | 60 | 60 |
| Block Copolymer, 20% EO | | |

Other co-surfactants suitable for tire shine formulations include castor oil ethoxylates, hydrogenated castor oil ethoxylates, oleyl alcohol (fatty alcohol) ethoxylates, tridecyl alcohol ethoxylates, nonyl phenol ethoxylates, tallow amine ethoxylates, methyl oxirane copolymers (e.g., Meroxapol® 174), lauryl alcohol ethoxylates, C₁₂-C₁₄ and C₁₀-C₁₆ alcohol ethoxylates, C₁₃-C₁₅ alcohol ethoxylates, C₁₀ Guerbet alcohol alkoxylates, decyl alcohol ethoxylates, dodecyl alcohol ethoxylates, ethylhexyl alkoxylates, C₉-C₁₁ alcohol ethoxylates, octyl phenol ethoxylates, polyoxyethylene-polyoxypropylene block co-polymers, alkoxylated fatty alcohols, PEG esters, fatty amine ethoxylates, C₁₂-C₁₅ alcohol ethoxylates, ethoxylated glyceryl esters, fatty alcohol ethoxylates, glycerol esters, ethoxylated sorbitan ester, quaternary ammonium compounds, aliphatic amines, or combinations thereof.

### Vinyl Polish Formulations:

| | F8 | F9 | F10 | F11 |
|---|---|---|---|---|
| Ingredients | wt. (%) | wt. (%) | wt. (%) | wt. (%) |
| Soft or DI Water | 50 | 70 | 70 | 85 |
| Benchmark 1 | 25 | | | |
| Benchmark 2 | 25 | | | |
| Glycerin | | 30 | | |
| Emulsion 2 | | | 30 | 15 |

| | F12 | F13 | F14 |
|---|---|---|---|
| Ingredients | wt. (%) | wt. (%) | wt. (%) |
| Organic solvent (e.g., C₁₂-C₁₄ | 70 | 80 | 90 |
| Isoparaffin, >160 °F FP) | | | |
| 350 cst Polydimethylsiloxane Fluid | 15 | | |
| 1000 cst Polydimethylsiloxane Fluid | 15 | | |
| Ethylene Oxide/Propylene Oxide | | 20 | 10 |
| Block Copolymer, 20% EO | | | |

| | F15 | F16 |
|---|---|---|
| Ingredients | wt. (%) | wt. (%) |
| Soft or DI water | 35 | 15 |
| Solubilizing solvent (e.g., | 5 | 25 |
| di(propylene glycol) methyl ether) | | |
| Ethylene Oxide/Propylene Oxide | 60 | 60 |
| Block Copolymer, 20% EO | | |

Other co-surfactants suitable for vinyl formulations include castor oil ethoxylates, hydrogenated castor oil ethoxylates, oleyl alcohol (fatty alcohol) ethoxylates, tridecyl alcohol ethoxylates, nonyl phenol ethoxylates, tallow amine ethoxylates, methyl oxirane copolymers (e.g., Meroxapol® 174), lauryl alcohol ethoxylates, C₁₂-C₁₄ and C₁₀-C₁₆ alcohol ethoxylates, C₁₃-C₁₅ alcohol ethoxylates, C₁₀ Guerbet alcohol alkoxylates, decyl alcohol ethoxylates, dodecyl alcohol ethoxylates, ethylhexyl alkoxylates, C₉-C₁₁ alcohol ethoxylates, octyl phenol ethoxylates, polyoxyethylene-polyoxypropylene block co-polymers, alkoxylated fatty alcohols, PEG esters, fatty amine ethoxylates, C₁₂-C₁₅ alcohol ethoxylates, ethoxylated glyceryl esters, fatty alcohol ethoxylates, glycerol esters, ethoxylated sorbitan ester, quaternary ammonium compounds, aliphatic amines, or combinations thereof.

### Example 5

### Qualitative Testing

Three samples were sprayed onto a tire wall in three separate sets. Ten panelists compared samples to each other, within each set, and rated them from 1-5 for gloss. The gloss rating key was as follows: 1=clearly worse, 2=slightly worse, 3=same, 4=slightly better, 5=clearly better.

The panelists rated the samples in four intervals after application: initial, 24 hours, 48 hours, and 1 week. The panelists were unaware of identity of products in each set. The below table includes the averages and standard deviations of gloss values for each time point across all comparisons.

### Benchmark 3: 20% Silicone Emulsion

### Benchmark 4: 20% Glycerin

### Gloss Ratings.

| Sample | Initial | 24 hours | 48 hours | 1 week |
|---|---|---|---|---|
| Benchmark 3 | 2.50 ± 0.63 | 3.03 ± 0.56 | 3.20 ± 0.41 | 3.27 ± 0.45 |
| Benchmark 4 | 2.97 ± 0.72 | 2.30 ± 0.47 | 2.20 ± 0.41 | 2.27 ± 0.52 |
| 33% Emulsion | 4.07 ± 0.74 | 4.40 ± 0.62 | 4.73 ± 0.45 | 4.63 ± 0.61 |
| 2 | | | | |

These results demonstrate that an emulsion according to the present disclosure qualitatively outperforms benchmark formulations containing silicone or glycerin active ingredients. Outperformance is observed in initial gloss, short-term gloss, and long-term gloss.

### Example 6

### Quantitative Testing

A ½″ thick heavy-duty styrene butadiene rubber sheeting of 60A durometer was cut and cleaned with acetone to remove any surface film. The sheet was divided into three sections and onto each section a product was applied using a foam brush. For each section, three gloss measurements were taken with a gloss meter (BYK Gardner micro-TRI-gloss glossmeter) at four intervals after application: initial, 24 hours, 48 hours, and 1 week. The below table includes the averages of gloss values, measured in gloss units (GU), for each time point across all measurements.

### Gloss Ratings.

| Sample | Unshined | Initial | 24 hours | 48 hours | 1 week |
|---|---|---|---|---|---|
| Benchmark 3 | 22.3 | 56.0 | 54.8 | 48.5 | 46.5 |
| Benchmark 4 | 24.3 | 31.3 | 30.1 | 26.9 | 26.3 |
| 33% Emulsion 2 | 25.0 | 69.9 | 69.3 | 71.1 | 75.8 |

These results demonstrate that an emulsion according to the present disclosure quantitatively outperforms benchmark formulations containing silicone or glycerin active ingredients. Outperformance is observed in initial gloss, short-term gloss, and long-term gloss.

It was discovered herein that compositions and methods in accordance with the present disclosure may provide a non-silicone-based compound having gloss enhancing and surface protecting properties, as well as longevity and water and/or detergent resistance.

While embodiments of the present disclosure have been described, it should be understood that the present disclosure is not so limited and modifications may be made without departing from the present disclosure. The scope of the present disclosure is defined by the appended claims, and all devices, processes, and methods that come within the meaning of the claims, either literally or by equivalence, are intended to be embraced therein.

1. An aqueous composition comprising a water insoluble surfactant in an amount effective to impart appearance enhancing and protectant properties when the composition is applied to a substrate surface and a suitable carrier.

2. The aqueous composition of claim 1, wherein the water insoluble surfactant is selected from the group consisting of fatty alcohol ethoxylates, polyoxyethylene-polyoxypropylene block polymers, and combinations thereof.

3. The aqueous composition of claim 1, wherein the water insoluble surfactant is characterized by an HLB of less than 6.0.

4. The aqueous composition of claim 1, wherein the composition further comprises silicone in an amount less than or equal to 50 wt %.

5. The aqueous composition of claim 1, wherein the composition is free of silicone.

6. The aqueous composition of claim 1, wherein the water insoluble surfactant is present in an amount of about 5% to about 60% by weight of the aqueous composition.

7. The aqueous composition of claim 1, wherein the composition further comprises a co-surfactant.

8. The aqueous composition of claim 7, wherein the composition is in the form of an emulsion.

9. The aqueous composition of claim 1, wherein the carrier comprises water.

10. A method of using an aqueous composition, the method comprising applying the aqueous composition of claim 1 to a substrate.

11. The method of claim 10, wherein the substrate comprises a material selected from the group consisting of rubber, vinyl, leather, and combinations thereof.

12. A non-aqueous composition comprising a water insoluble surfactant in an amount effective to impart appearance enhancing and protectant properties when the composition is applied to a substrate surface and a suitable carrier.

13. The non-aqueous composition of claim 12, wherein the water insoluble surfactant is selected from the group consisting of fatty alcohol ethoxylates, polyoxyethylene-polyoxypropylene block polymers, and combinations thereof.

14. The non-aqueous composition of claim 12, wherein the carrier is selected from the group consisting of glycol ethers, alcohols, mineral spirits, aliphatic solvents, aromatic solvents, and mixtures thereof.

16. The non-aqueous composition of claim 12, wherein the water insoluble surfactant is present in an amount of about 5% to about 60% by weight of the non-aqueous composition.

17. The non-aqueous composition of claim 12, wherein the composition further comprises silicone in an amount less than or equal to 50 wt %.

18. The non-aqueous composition of claim 12, wherein the composition is free of silicone.

19. A method of using a non-aqueous composition, the method comprising applying the non-aqueous composition of claim 12 to a substrate.

20. The method of claim 19, wherein the substrate comprises a material selected from the group consisting of rubber, vinyl, leather, and combinations thereof.
